(19) United States
(12) Patent Application Publication
(10) Pub. No.: US 2005/0281168 A1
(43) Pub. Date: Dec. 22, 2005

(54) System of sampling interface for an optical pick-up head

(75) Inventor: Chih-Min Liu, Taipei (TW)

Correspondence Address: GENESIS/GENUS LAW GROUP, 12760 HIGH BLUFF DRIVE, SUITE 300, SAN DIEGO, CA, 92130, US

(73) Assignee: VIA TECHNOLOGIES

(21) Appl. No.: 11/090,020

(22) Filed: Mar. 28, 2005

(30) Foreign Application Priority Data
Jun. 18, 2004 (TW) 093117647

(51) Int. Cl. G11B 7/00

(52) U.S. Cl. 369/100; 369/44.34

(57) ABSTRACT

A system of sampling interface for an optical pick-up head includes an optical pick-up head, a switch circuit and a sample and hold circuit. The optical pick-up head outputs one of a reading voltage and a writing voltage. The switch circuit includes a NMOS. The NMOS has a first source/drain for receiving the reading voltage and the writing voltage, and has a gate for receiving the gate voltage. The NMOS turns on the first source/drain and the second source/drain when receiving the reading voltage, and turns them off when receiving the writing voltage. Finally, a sample and hold circuit connects to the second source/drain of the NMOS for sampling and holding the reading voltage.

### BACKGROUND OF THE INVENTION

1. Field of the Invention

The present invention is generally related to an interface circuit system, and more particularly to a sampling interface circuit for providing the functions of signal sample and hold between the circuits with a different working voltage. And the interface circuit system could protect the circuits with a lower working voltage during the high voltage operation.

2. Description of the Prior Art

When a signal is transmitted from a circuit with a higher working voltage to a circuit with a lower working voltage, an interface circuit has to exist between the two circuits to weaken the signal to the voltage accepting range of the circuit with a lower working voltage. For example, the working voltage of a general optical pick-up head is 5 volts, and the working voltage of an optical disk driver (CD-ROM) control chip 100 is 3.3 volts. If the writing voltage output by optical pick-up head is directly input into the CD-ROM control chip 100, the input end oxide layer of 3.3 volts process will collapse and the chip will become permanently damaged after long time stress.

The prior is showing in FIG. 1, the optical pick-up head has a voltage input 101, the voltage input 101 could be one of a writing voltage (between 3.3 volts and 5 volts) and a reading voltage (between 1.4 volts and 2.8 volts). Using the voltage divider composed of the first voltage divider resistor 102 and the second voltage divider resistor 103 to weaken the writing voltage under 3.3 volts, that is the voltage accepting range of a CD-ROM control chip. The input end oxide layer of CD-ROM control chip 100 could avoid collapsing; because the writing voltage is controlled under 3 volts by the voltage divider. The reading voltage produced by the voltage input 101 uses the input end of a CD-ROM control chip such as the switched operation amplifier (SOP) to sample and hold signal to produce an output voltage 105 for the internal part of CD-ROM control chip.

The optical pick-up head has to supply additional current for the path “I” produced by the voltage divider, which consumes additional power and causes thermal noise. If the resistance of the resistor 102 and resistor 103 are bigger and then the settling time of the input end of SOP is bigger so that the sampling time reduces. The voltage divider weakens not only the writing voltage that is not for sampling but also the reading voltage that is for sampling. If the weakened reading voltage combines with the back end noise, then the signal noise rate (SNR) will be reduced. Besides, two resistors cover a big area of a chip.

### SUMMARY OF THE INVENTION

According to the above-mentioned, the prior art has to supply additional current to drive the resistor. The bigger resistance is, the bigger settling time of the SOP is, so that the sampling time is reduced. Furthermore, not only the writing voltage that is not for sampling is weakened but also the reading voltage that is for sampling is weakened.

One purpose of present invention is that the voltage divider is replaced by the N-TYPE MOS (NMOS) to reduce the load of the optical pick-up head, and doesn't weaken the reading voltage for enhancing SNR. Furthermore, the settling time of the SOP is reduced so that the sampling time is increased and power consumption is reduced.

One embodiment of the present invention provides a system for a sampling interface for an optical pick-up head, which includes an optical pick-up head, a switch circuit and a sample and hold circuit. The optical pick-up head outputs one of the reading voltage and the writing voltage. The switch circuit includes a NMOS. The NMOS has a first source/drain for receiving the reading voltage and the writing voltage, and has a gate for receiving the gate voltage. The NMOS turns on the first source/drain and the second source/drain when receiving the reading voltage, and turns off the first source/drain and the second source/drain when receiving the writing voltage. Finally, a sample and hold circuit connects to the second source/drain of the NMOS for sampling and holding the reading voltage.

Another purpose of present invention is using an auxiliary path to weaken the high reading voltage. Some of the high reading voltage will lead to problems because the specifications of different kinds of optical pick-up heads are not the same. And then the auxiliary path circuit is applied to provide a suitable reading voltage for the CD-ROM control chip. Hence, the present invention provides another system of sampling interface for the optical pick-up head. The system includes an optical pick-up head, a switch circuit, an auxiliary path circuit and a sample and hold circuit. The optical pick-up head outputs one of the reading voltage and the writing voltage. The switch circuit includes a NMOS. The NMOS has a first source/drain for receiving the reading voltage and the writing voltage, and has a gate for receiving the gate voltage. The NMOS turns on the first source/drain and the second source/drain when receiving the reading voltage, and turns off the first source/drain and the second source/drain when receiving the writing voltage. An auxiliary path circuit connects the first source/drain and the second source/drain to keep the voltage the same between the first source/drain and the second source/drain. Finally, a sample and hold circuit connects to the second source/drain of the NMOS for sampling and holding the reading voltage.

### BRIEF DESCRIPTION OF THE DRAWINGS

FIG. 1 is a schematic system of sampling interface for an optical pick-up head in accordance with a conventional prior art;

FIG. 2 is a schematic representation of preferred embodiment in accordance with the present invention;

FIG. 3 is a schematic representation of another preferred embodiment in accordance with the present invention;

FIG. 4 is a schematic representation of another preferred embodiment in accordance with the present invention;

FIG. 5 is a schematic representation of another preferred embodiment in accordance with the present invention; and

FIG. 6 is a schematic representation of another preferred embodiment in accordance with the present invention.

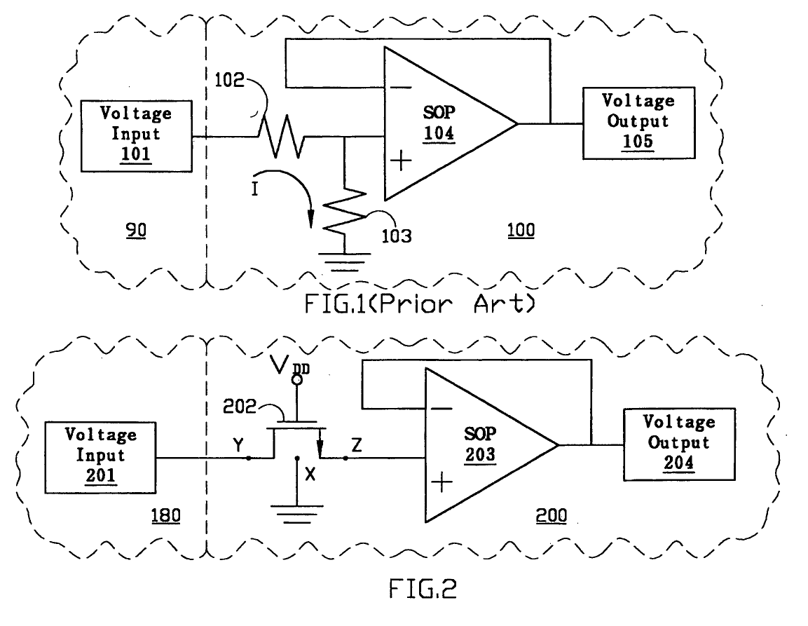

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

Referring to FIG. 2 in accordance with an embodiment of the present invention, the voltage input 201 is output by the optical pick-up head 180, this voltage at the minimum could be one of a reading voltage (between 1.4 volts and 2.8 volts) and a writing voltage (between 3.3 volts and 5 volts). A switch circuit (NMOS 202 is a representative) is used as the first path circuit and placed between the optical pick-up head 180 and SOP 203 to receive the reading voltage and writing voltage. The above-mentioned writing voltage and reading voltage could alternately appear. Moreover, the switch circuit such as the NMOS 202 disconnects the writing voltage and properly transmits the reading voltage to the SOP 203. The first source/drain of the NMOS 202 receives the voltage input 201, and the second source/drain of the NMOS 202 connects with the SOP 203, and then the gate of the NMOS 202 is controlled by a gate voltage V_{DD}, the operation is described as follows:

When the voltage input 201 is the reading voltage (between 1.4 volts and 2.8 volts), the NMOS 202 turns on so that the voltage remains constant between the first source/drain of the NMOS 202 and the second source/drain of the NMOS 202. Then, the reading voltage is directly transmitted to the SOP 203 for sampling and produces an output voltage 204. If the voltage input 201 is the writing voltage (between 3.3 volts and 5 volts), the voltage of the first source/drain of the NMOS 202 is between 3.3 volts and 5 volts. Hence, a reversed biased diode is formed between the substrate (represented as “X”) and the first source/drain (represented as “Y”), and the path between the first source/drain “Y” and the second source/drain (represented as “Z”) turns off. Therefore, the writing voltage is disconnected because the writing voltage could not be transmitted to the SOP 203 via NMOS 202. Subject to the control of the gate voltage and the channel limitation, the output voltage of the second source/drain “Z” is (V_{DD} minus Vt (not shown)). The above-mentioned V_{DD} is the working voltage of the optical control chip and the working voltage is generally at 3.3 volts. Vt is the threshold voltage of the NMOS 202 and generally is at 0.7 volts. Hence, (V_{DD} minus Vt) equals 2.6 volts, so as to input into SOP 203 and the oxide layer won't collapse due to the high voltage input. The SOP 203 won't sample the (V_{DD} minus Vt) transmitted by the second source/drain “Z” because the voltage input is the writing voltage. It is noted that the above-mentioned SOP 203 could be replaced by any sample and hold circuit, the description here is just a preferred embodiment. Because the reading voltage directly inputs to the sample and hold circuit, hence, the reading voltage won't be decayed by using resistors, and then the SNR is improved. Furthermore, without the resistors, the sampling time won't be substantially increased, there is no power consumption and the size of chip could be saved.

In general, most factory owners avoid using a reading voltage over 2.6 volts. Accordingly, the maximum voltage of the second source/drain of the NMOS is limited to (V_{DD} minus Vt) (for example: 2.6 volts) even though the reading voltage used is too high (over V_{DD} minus Vt). That means that the NMOS 202 will be blocked high reading voltage for fear of damaging CD-ROM. In the present invention, an additional circuit associates with the first path to solve the problem. Some preferred embodiments would be illustrated as follow.

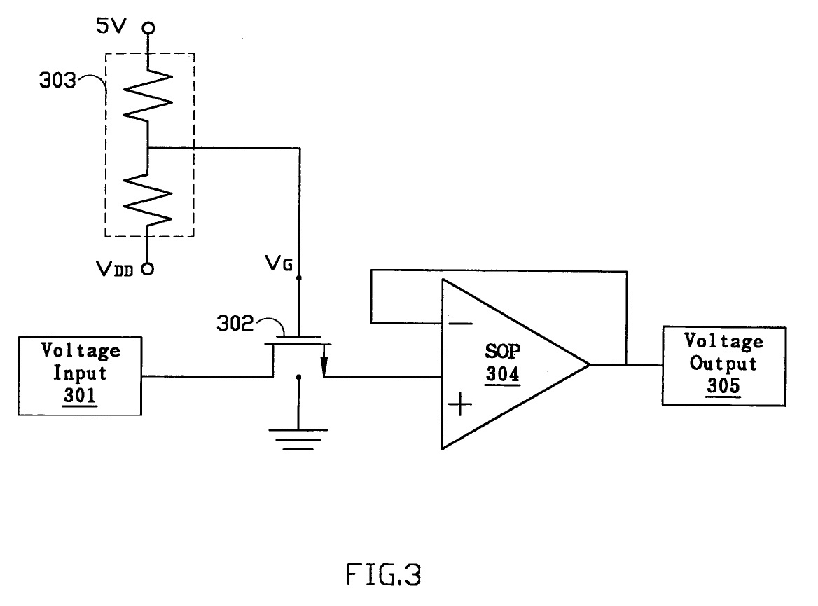

For overcoming the problem of using a high reading voltage, first, we turn the gate voltage to high so that the entire reading voltage range possible could be lower than the gate voltage. Referring to FIG. 3, the circuit is similar to the one in FIG. 2. The reading voltage from the voltage input 301 passes through the NMOS 302 and inputs into the sample and hold circuit such as SOP 304 to then generate an output voltage 305. Moreover, in this embodiment, a voltage divider 303 adopts the metal change technique to control the gate voltage V_{G} of the NMOS 302. The voltage divider is placed between the optical pick-up head and the CD-ROM control chip. The voltage of the optical pick-up head is at 5 volts and the voltage of the CD-ROM is at 3.3 volts. One purpose of this embodiment is to avoid the reading voltage of the voltage input 301 is too high, for example, the reading voltage over or equal to 2.6 volts. For instance, when the reading voltage of the voltage input 301 is 2.6 volts and writing voltage is 5.5 volts, the voltage divider 303 controls the gate voltage V_{G} of the NMOS 302 to be 3.5 volts. Then, the highest voltage of the source of NMOS 302 could be 3.5 volts minus Vt, and is at 2.8 volts. Hence, the NMOS 302 could receive the reading voltage, which is 2.6 volts without problems, and the high writing voltage, which is at 5.5 volts would be disconnected.

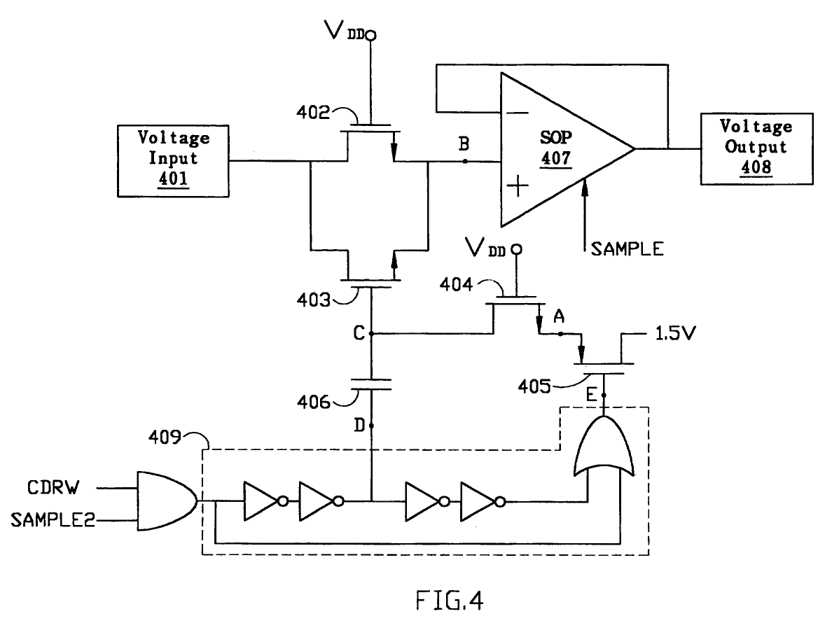

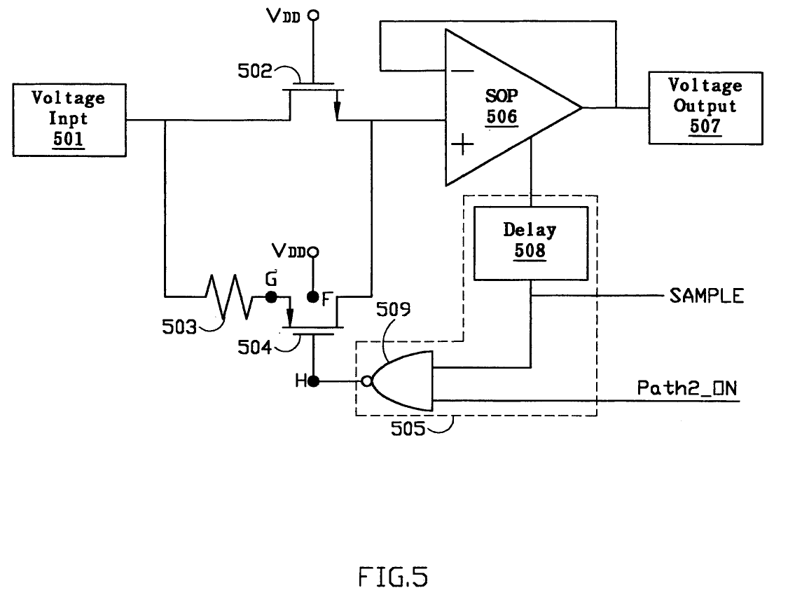

Furthermore, for overcoming the problem of high reading voltage, we construct an auxiliary path circuit between the first source/drain and the second source/drain as shown in FIG. 2, and then the first source/drain could properly connect with the second source/drain so the sample and hold circuit could get a higher reading voltage. Referring to FIG. 4, the circuit is similar to the one in FIG. 2. The reading voltage is received from the voltage input 401 via the NMOS 402, the reading voltage is inputted into the SOP 407, finally, a output voltage 408 is produced and the gate of the NMOS 402 is controlled by the gate voltage V_{DD}. In this embodiment, an auxiliary path circuit is placed between the first source/drain of the NMOS 402 and the second source/drain of the NMOS 402 to process the situation that NMOS 402 receives a high reading voltage. The auxiliary path circuit includes NMOS 403, a capacitor 406 and a logic circuit 409, wherein the logic circuit 409 is composed of several OR gates and inverters. Besides, the auxiliary path circuit could further comprise NMOS 404 and NMOS 405.

In the embodiment, when the voltage input 401 is too high, the CDRW will be set to 1 so that the capacitor 406 can increase the voltage. For example, the point “C” is increased to 4.8 volts (1.5 plus 3.3), and then the NMOS 403 is main transmit path so that the highest voltage range of the point “B” is increased. The advantages are, the voltage over the circuit support will only happen when the CDRW is 1, and it only happens on NMOS 403. Adjusting the end 1.5 volts in FIG. 4 could change the voltage. The circuit operation is described as follows: at first, the system provides two clock signals, SAMPLE and SAMPLE2, and the duty cycle of two clock signals is adjustable. The duty cycle of SAMPLE2 has to be longer than SAMPLE so as to ensure the sampling after the point “B” has been completed. The function of the logic circuit 409 is to allow the duty cycle of the point “E” to be longer than the point “D” for making the point “C” closer to 1.5 volts. Besides, the PMOS 405 turns on again to avoid the unnecessary charge and discharge (Because the drain of the PMOS connects to 1.5 volts end). The NMOS 404 is used to protect the PMOS 405. The NMOS 404 limits point “A” is not over 3.3 volts so as to protect the PMOS 405 when the voltage of the point “C” goes over 3.3 volts. A brief description is as follows: The SAMPLE and SAMPLE2 are signals for sampling and holding; the two signals are for sampling when the reading voltage is inputted; the two signals are not for sampling and maintains a previous state when other voltages such as the writing voltage is input. The CDRW is the signal for starting the auxiliary path circuit. When the reading voltage is too high (over 2.6 volts), the auxiliary path circuit is started. And the reading voltage samples in the sample and hold circuit such as the SOP via the auxiliary path circuit. Finally, the reading voltage is output.

Referring to FIG. 5 in accordance with another embodiment of the present invention. This circuit is similar to the one in FIG. 2. The reading voltage is received from the voltage input 501 via the NMOS 502, the reading voltage is input into the SOP 506, SAMPLE controls the sample function of the SOP 506, finally, an output voltage 507 is produced. The gate of the NMOS 502 is controlled by the V_{DD}, an auxiliary path circuit is placed between the first source/drain of the NMOS 502 and the second source/drain of the NMOS 502 to process the situation that the NMOS 502 receives a high reading voltage. The auxiliary path circuit includes a resistor 503 and PMOS 504. Furthermore, the logic circuit 505 includes a NAND gate 509 and a delay circuit 508.

In this embodiment, if the reading voltage is not over (V_{DD} minus Vt), and then the Path2_ON=0, the auxiliary path circuit is closed. When the voltage input 501 is a high reading voltage, and then the Path2_ON=1, the SAMPLE is equal to 1 for sampling. After the process of the NAND gate 509, the low voltage of the point “H” turns on the PMOS 504. The NMOS 502 could receive higher reading voltage because the auxiliary path circuit connects the first source/drain of the NMOS 502 and the second source/drain of the NMOS 502. On the other hand, if the voltage input 501 is a writing voltage, the voltage of the point “G” is one Vt more than the point “F” due to the resistor 503. The voltage of the point “G” is at around 4 volts and the maximum voltage of the voltage input 501 is 5 volts. The resistor 503 here limits the current, and the V_{DD} only consumes part of the systems power. At the same time, H=F=V_{DD} (SAMPLE=0), the PMOS 504 turns off and the writing voltage is disconnected as shown in FIG. 2. Besides, when the logic circuit 505 turns on the auxiliary path circuit, the high reading voltage must be set by the resistor 503 and the delay of one time constant is needed. Hence, the delay circuit 508 of the logic circuit 505 connects with the control end of the SOP 506 to the delay signal.

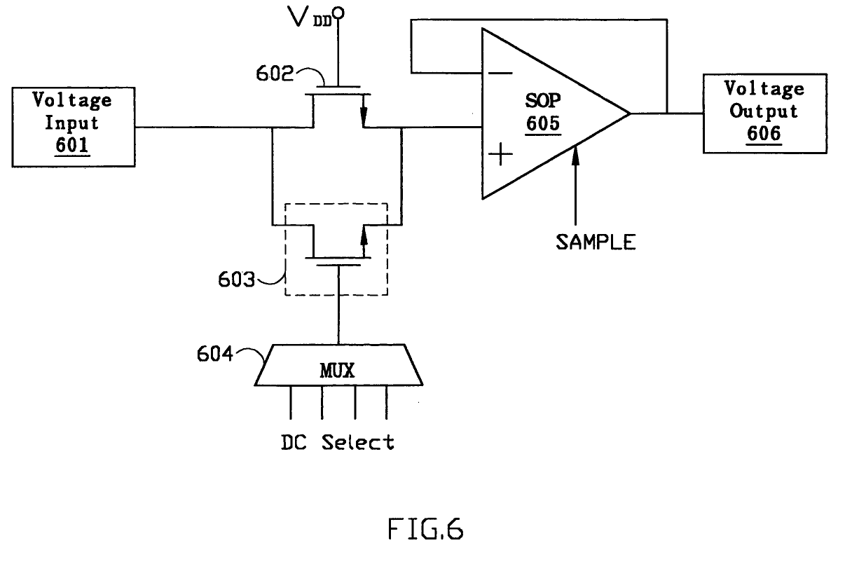

Referring to FIG. 6 in accordance with another embodiment of the present invention. This circuit is similar to the one in FIG. 2. The reading voltage is received from the voltage input 601 via the NMOS 602, the reading voltage is input into the SOP 605, SAMPLE controls the sample function of SOP 506, finally, an output voltage 606 is produced. The gate of the NMOS 502 is controlled by V_{DD}, an auxiliary path circuit is placed between the first source/drain of the NMOS 602 and the second source/drain of the NMOS 602, wherein the auxiliary path circuit includes a Native NMOS 603 and a multiplexer 604. The Native NMOS 603 is a component for processing an electrostatic circuit. In the deep submicron process, the NMOS assembled on a P-substrate can't operate in the normal working region, so the NMOS is actually assembled on the P-well in an advanced process. At the same time, the NMOS assembled on the P-substrate is still used, and is called a Native NMOS.

In this embodiment, the Native NMOS 603 parallel connects with a general NMOS 602, and a multiplexer 604 chooses one of several direct voltages to be a control voltage. When the general NMOS 602 processes a normal reading voltage (under 2.6 volts), the multiplexer 604 chooses a control voltage such as 0 volts to close the auxiliary path circuit with the Native NMOS 603. If the reading voltage is too high, the multiplexer will choose a control voltage. Besides, the Vt of Native NMOS 603 is very small even negative, hence the auxiliary path circuit is turned on. And then the problem of high reading voltage is solved.

Although specific embodiments have been illustrated and described, it will be obvious to those skilled in the art that various modifications may be made without departing from what is intended to be limited solely by the appended claims.

1. A system of sampling interface for an optical pick-up head, said system comprising:
said optical pick-up head for outputting one of a reading voltage and a writing voltage;
a switch circuit including a N-TYPE Metal Oxide Semiconductor (NMOS), wherein said NMOS has a first source/drain for receiving said reading voltage and said writing voltage and a gate for receiving a gate voltage, and said NMOS turns on said first source/drain and a second source/drain when receiving said reading voltage, and turns off said first source/drain and said second source/drain when receiving said writing voltage; and
a sample and hold circuit connecting said second source/drain for sampling and holding said reading voltage.

2. The system according to claim 1, wherein said writing voltage is higher than said reading voltage.

3. The system according to claim 2, wherein said writing voltage is between 3.5 volts and 5 volts and said reading voltage is between 1.4 volts and 2.8 volts.

4. The system according to claim 1, wherein said switch circuit further comprises a voltage divider connecting said gate for controlling said gate voltage.

5. The system according to claim 1, wherein said NMOS turns off when said first source/drain receives said writing voltage and said second source/drain voltage is equal of said gate voltage minus a threshold voltage of said NMOS.

6. The system according to claim 1, wherein said sample and hold circuit is a switched operation amplifier (SOP).

7. A system of sampling interface for an optical pick-up head, said system comprising:
said optical pick-up head for outputting one of a reading voltage and a writing voltage;
a switch circuit including a NMOS, wherein said NMOS has a first source/drain for receiving said reading voltage and said writing voltage and a gate for receiving a gate voltage, and said NMOS turns on said first source/drain and a second source/drain when receiving said reading voltage, and turns off said first source/drain and said second source/drain when receiving said writing voltage;
an auxiliary path circuit connecting said first source/drain and said second source/drain to keep voltage the same between said first source/drain and said second source/drain; and
a sample and hold circuit connecting to said second source/drain for sampling and holding said reading voltage.

8. The system according to claim 7, wherein said auxiliary path circuit at least includes an auxiliary NMOS and a capacitor, two source/drain of said auxiliary NMOS separately connect to said first source/drain and said second source/drain, and said capacitor connects to a gate of said auxiliary NMOS to enhance a reading voltage receiving range of said second source/drain.

9. The system according to claim 7, wherein said auxiliary path circuit at least includes a resistor, a P-TYPE MOS (PMOS) and a control circuit, one end of said resistor connects with said first source/drain, the two source/drain of said PMOS separately connect with the other end of said resistor and said second source/drain, said control circuit controls said PMOS to turn on.

10. The system according to claim 9, wherein said control circuit includes a delay circuit and a logic circuit, said delay circuit connects with said sample and hold circuit to delay the operation time of said sample and hold circuit, and said logic circuit decides said PMOS to turn on according to said reading voltage and said writing voltage.

11. The system according to claim 7, wherein said auxiliary path circuit includes a Native NMOS and a multiplexer, two source/drain of said Native NMOS separately connect with said first source/drain and said second source/drain, said multiplexer chooses a control voltage to input to a gate of said Native NMOS.

12. The system according to claim 7, wherein said writing voltage is higher than said reading voltage.

13. The system according to claim 12, wherein said writing voltage is between 3.3 volts and 5 volts and said reading voltage is between 1.4 volts and 2.8 volts.

14. The system according to claim 7, wherein said NMOS turns off when said first source/drain receives said writing voltage, and said second source/drain voltage is equal of said gate voltage minus a threshold voltage of said NMOS.

15. The system according to claim 7, wherein said sample and hold circuit is a SOP.

16. An interface circuit for receiving and outputting a first voltage input, and isolating the output of a second voltage input, wherein said interface circuit comprising:
a switch circuit including a NMOS, wherein said NMOS has a first source/drain for receiving said first voltage input and said second voltage input and a gate for receiving a gate voltage, said NMOS turns on said first source/drain and said second source/drain when receiving said first voltage input, and turns off said first source/drain and said second source/drain when receiving said second voltage input; and
an auxiliary path circuit connecting said first source/drain and said second source/drain to keep voltage the same between said first source/drain and said second source/drain.

17. The system according to claim 16, wherein said auxiliary path circuit at least includes an auxiliary NMOS and a capacitor, two source/drain of said auxiliary NMOS separately connect to said first source/drain and said second source/drain, said capacitor connects to a gate of said auxiliary NMOS to enhance a reading voltage receiving range of said second source/drain.

18. The system according to claim 16, wherein said auxiliary path circuit at least includes a resistor, a PMOS and a control circuit, one end of said resistor connects with said first source/drain, two source/drain of said PMOS separately connect with the other end of said resistor and said second source/drain, and said control circuit controls said PMOS to turn on.

19. The system according to claim 16, wherein said auxiliary path circuit includes a Native NMOS and a multiplexer, two source/drain of said Native NMOS separately connects with said first source/drain and said second source/drain, said multiplexer chooses a control voltage to input a gate of said Native NMOS.

20. The system according to claim 16, wherein said second voltage input is higher than said first voltage input.
